(19) United States
(12) Patent Application Publication
(10) Pub. No.: US 2014/0027541 A1
(43) Pub. Date: Jan. 30, 2014

(54) Fuel Injection Valve

(71) Applicant: Hitachi Automotive Systems, Ltd., Hitachinaka-shi (JP)

(72) Inventors: Yoshio OKAMOTO, Omitama-shi (JP); Yoshihito YASUKAWA, Hitachinaka-shi (JP); Noriyuki MAEKAWA, Kashiwa-shi (JP); Eiji ISHII, Hitachinaka-shi (JP); Kazuki YOSHIMURA, Hitachinaka-shi (JP); Takahiro SAITO, Isesaki-shi (JP); Nobuaki KOBAYASHI, Maebashi-shi (JP)

(73) Assignee: Hitachi Automotive Systems, Ltd., Hitachinaka-shi (JP)

(21) Appl. No.: 13/948,844

(22) Filed: Jul. 23, 2013

(30) Foreign Application Priority Data
Jul. 25, 2012 (JP) 2012-164293

(51) Int. Cl. F02M 61/16

(52) U.S. Cl. CPC F02M 61/163
USPC 239/486

(57) ABSTRACT

A fuel injection valve which ensures improved uniformity of a swirl flow in a circumferential direction. It includes: a valve element provided movably; a nozzle body with an opening downstream, including a valve seat face for the valve element to rest on in a valve closed state; a swirling path communicating with the opening of the nozzle body, located downstream of the opening; a swirling chamber located downstream of the swirling path, in which fuel is swirled and given a swirling force; and a fuel injection hole formed at the bottom of the swirling chamber to inject fuel outward. The swirling chamber has an inner wall surface which makes a spiral curve. The swirling chamber and the fuel injection hole are formed so that the center of a base circle for the spiral curve coincides with the center of the fuel injection hole.

### CLAIM OF PRIORITY

The present application claims priority from Japanese Patent application serial No. 2012-164293, filed on Jul. 25, 2012, the content of which is hereby incorporated by reference into this application.

### FIELD OF THE INVENTION

The present invention relates to a fuel injection valve for use in an internal combustion engine and more particularly to a fuel injection valve which injects swirling fuel and can improve atomization performance.

The fuel injection valve described in JP-A-2003-336562 is known as a related art technique which uses a swirl flow to accelerate the atomization of fuel injected from a plurality of fuel injection holes.

### BACKGROUND OF THE INVENTION

This fuel injection valve includes: a valve seat member having a front end face to which the downstream end of a valve seat to work with a ball valve opens; a horizontal path which communicates with the downstream end of the valve seat between the valve seat member and an injector plate joined to the front end face of the valve seat member; and a swirling chamber to which the downstream end of the horizontal path opens in a tangential direction. Fuel injection holes for injecting fuel to which swirl is given in the swirling chamber are pierced in the injector plate and each of the fuel injection holes is located toward the upstream end of the horizontal path by a given distance off the center of the swirling chamber.

In this fuel injection valve, the curvature radius of the inner circumferential surface of the swirling chamber decreases in the direction from upstream to downstream along the inner circumferential surface of the swirling chamber. In other words, the curvature increases in the direction from upstream to downstream along the inner circumferential surface of the swirling chamber. Also the inner circumferential surface of the swirling chamber is formed along an involute curve with a base circle in the swirling chamber.

This structure accelerates the atomization of fuel injected from each fuel injection hole effectively.

### SUMMARY OF THE INVENTION

In the related art technique described in JP-A-2003-336562, one sidewall (connected to the upstream end of the swirling chamber inner circumferential wall in the fuel swirling direction) of the horizontal path is connected to the inner circumferential wall of the swirling chamber tangentially and the other sidewall (connected to the downstream end of the swirling chamber inner circumferential wall in the fuel swirling direction) is arranged in a way to intersect with the inner circumferential wall of the swirling chamber.

The joint at which the other sidewall and the swirling chamber inner circumferential wall intersect with each other has a sharp pointed shape like a knife edge. In addition, the fuel injection holes are located adjacent to the knife edge-like portion or away from the chamber center.

In this structure, a very slight misalignment of the sidewall of the horizontal path or the inner circumferential wall of the swirling chamber would be likely to cause a misalignment in the joint between the walls. Such misalignment in the joint might cause a sudden drift toward the fuel injection hole, impairing the symmetry (uniformity) of the swirl flow.

The present invention has been made in view of the above circumstances and has an object to provide a fuel injection valve which ensures improved uniformity of a swirl flow in a circumferential direction.

In order to achieve the above object, according to one aspect of the present invention, there is provided a fuel injection valve which includes: a valve element provided movably; a nozzle body including a valve seat face for the valve element to rest on in a valve closed state and having an opening downstream; a swirling path communicating with the opening of the nozzle body and being located downstream of the opening; a swirling chamber located downstream of the swirling path, in which fuel is swirled and given a swirling force; and a fuel injection hole formed at the bottom of the swirling chamber to inject fuel outward. The swirling chamber has an inner wall surface which makes a spiral curve and the swirling chamber and the fuel injection hole are formed so that the center of a base circle for the spiral curve coincides with the center of the fuel injection hole.

According to the present invention, the fuel led to the spirally curved inner wall of the swirling chamber moves toward the center (swirl center) of the base circle to draw the spiral curve. Therefore, a uniform swirl flow is formed in the fuel injection hole.

### BRIEF DESCRIPTION OF THE DRAWINGS

FIG. 1 is a longitudinal sectional view showing the general structure of a fuel injection valve according to the present invention, taken along the valve axis;

FIG. 2 is a longitudinal sectional view showing a nozzle body and its vicinity in the fuel injection valve according to the present invention;

FIG. 3 is a plan view of an orifice plate located at the bottom of the nozzle body of the fuel injection valve according to the present invention;

FIG. 4 is a plan view showing the relation among a swirling path, a swirling chamber, and a fuel injection hole in the fuel injection valve according to the present invention;

FIG. 5 illustrates how the spirally curved swirling chamber is formed in the fuel injection valve according to the present invention;

FIG. 6 is a plan view of an orifice plate without a center chamber in a fuel injection valve according to the present invention;

FIG. 7 is a plan view of an orifice plate in a fuel injection valve according to the present invention, in which swirling paths are not connected with each other; and

FIGS. 8A and 8B are plan views of a fuel flow in a fuel injection hole, in which FIG. 8A shows a fuel flow in the related art and FIG. 8B shows a fuel flow in the present invention and FIGS. 8C and 8D are sectional views of fuel injection perpendicular to the valve axis just after leaving the fuel injection hole, in which FIG. 8C shows an injection pattern in the related art and FIG. 8D shows an injection pattern in the present invention.

### DETAILED DESCRIPTION OF THE PREFERRED EMBODIMENTS

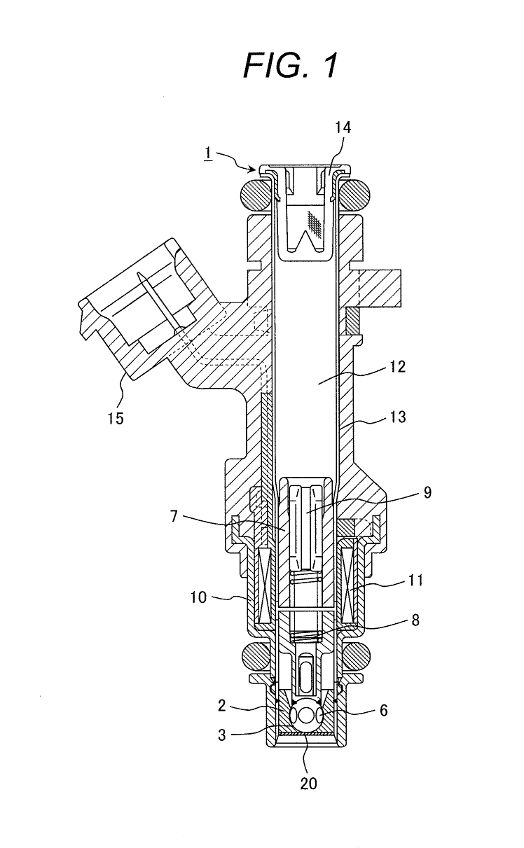

Next, a preferred embodiment of the present invention will be described referring to FIGS. 1 to 5. FIG. 1 is a longitudinal sectional view showing the general structure of a fuel injection valve 1 according to the present invention.

Referring to FIG. 1, in the fuel injection valve 1, a stainless steel thin-walled pipe 13 houses a nozzle body 2 and a valve element 6 and the valve element (ball valve) 6 is reciprocated (opening and closing motions) by an electromagnetic coil 11 located outside the pipe. Next, the structure will be described in detail.

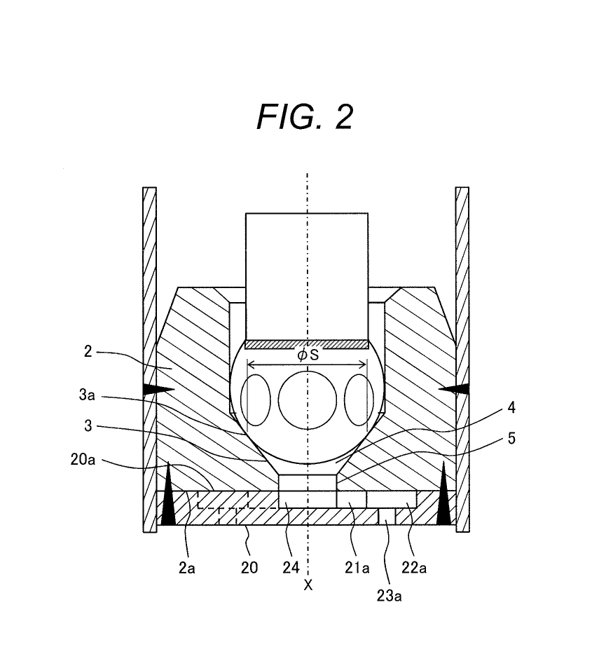

The fuel injection valve 1 includes a magnetic yoke 10 surrounding the electromagnetic coil 11, a core 7 located in the center of the electromagnetic coil 11 with one end in magnetic contact with the yoke 10, a valve element 6 to be lifted by a given amount, a valve seat face 3 in contact with the valve element 6, a fuel injection chamber 4 which allows fuel to pass through a gap between the valve element 6 and the valve seat face 3, and an orifice plate 20 with a plurality of fuel injection holes 23a, 23b, and 23c (see FIGS. 2 to 4) on the downstream of the fuel injection chamber 4.

A spring 8 as an elastic member which pushes the valve element 6 against the valve seat face 3 is provided in the center of the core 7. The elastic force of the spring 8 is adjusted according to the amount by which a spring adjuster 9 pushes the spring toward the valve seat face 3.

When the coil 11 is not energized, the valve element 6 and the valve seat face 3 are in contact with each other. In this state, the fuel path is closed and fuel stays inside the fuel injection valve 1 and is not injected from the fuel injection holes 23a, 23b, and 23c.

On the other hand, when the coil 11 is energized, the valve element 6 is moved by the electromagnetic force until it touches the lower end face of the core 7 facing it.

In this valve open state, a gap is produced between the valve element 6 and the valve seat face 3 and the fuel path is opened to allow fuel to be injected from the fuel injection holes 23a, 23b, and 23c.

The fuel injection valve 1 has a fuel path 12 with a filter 14 at the inlet and this fuel path 12 includes a portion penetrating the center of the core 7 and leads the fuel pressurized by a fuel pump (not shown) through the inside of the fuel injection valve 1 to the fuel injection holes 23a, 23b, and 23c. The outside of the fuel injection valve 1 is covered by a resin mold 15 and electrically insulated.

The fuel injection valve 1 controls the fuel feed rate by turning on or off electricity (injection pulse) to the coil 11 to change the position of the valve element 6 to its open or closed position as mentioned above.

For control of the fuel feed rate, the valve element is specially designed so that fuel leakage does not occur in the valve closed state.

In this type of fuel injection valve, a mirror-finished ball with a high roundness (ball bearing steel ball which conforms to JIS) is used for the valve element 6, contributing to improvement of seatability.

The valve seat angle of the valve seat face 3 to come into contact with the ball is in the range from 80 to 100 degrees which is optimum for the ball to have high grindability and high roundness, so that the valve seat face 3 provides high seatability for the ball.

The nozzle body 2, which includes the valve seat face 3, is a component which is quenched to increase hardness and demagnetized to remove unwanted magnetism.

The valve element 6 thus designed permits fuel injection rate control without fuel leakage. Therefore, this valve element structure is excellent in cost performance.

FIG. 2 is a longitudinal sectional view showing the nozzle body 2 and its vicinity in the fuel injection valve 1 according to the present invention. As shown in FIG. 2, the upper surface 20a of the orifice plate 20 is in contact with the bottom surface 2a of the nozzle body 2 and the periphery of this contact portion is fixed on the nozzle body 2 by laser welding.

In this specification and the appended claims, the expressions related to vertical directions are based on the upward and downward directions illustrated in FIG. 1. Specifically, in the valve axis direction (X in FIG. 2) of the fuel injection valve 1, the direction toward the fuel path 12 is upward and the direction toward the fuel injection holes 23a, 23b, and 23c is downward.

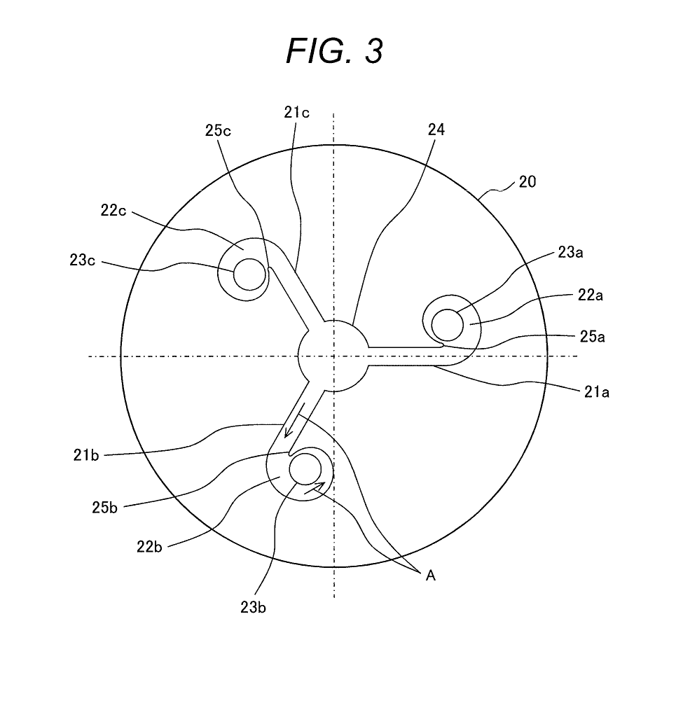

How fuel flows is indicated by the arrows A in FIG. 3.

In this specification, “upstream” and “downstream” refer to upstream and downstream in the direction of fuel flow.

A fuel introduction hole 5 with a smaller diameter than the diameter φS of a seat part 3a of the valve seat face 3 is provided at the bottom of the nozzle body 2. The valve seat face 3 has a conical shape and the fuel introduction hole 5 is formed in the center of its downstream end.

The valve seat face 3 and the fuel introduction hole 5 are formed so that the centerline of the valve seat face 3 and the centerline of the fuel introduction hole 5 align with the valve axis. The fuel introduction hole 5 forms, in the bottom surface 2a of the nozzle body 2, an opening communicating with a center hole 24 of the orifice plate 20.

Next, the structure of the orifice plate 20 will be described referring to FIG. 3. FIG. 3 is a plan view of the orifice plate 20 which is located at the bottom of the nozzle body 2 of the fuel injection valve 1 according to the present invention.

A center chamber 24 is provided as a concave in the upper surface 20a of the orifice plate 20. The center chamber 24 is connected to three swirling paths 21a, 21b, and 21c which are disposed at regular intervals (120 degrees) in the circumferential direction and extend radially toward the outer circumference of the orifice plate.

The downstream end of the swirling path 21a is communicated with a swirling chamber 22a, the downstream end of the swirling path 21b is communicated with a swirling chamber 22b, and the downstream end of the swirling path 21c is communicated with a swirling chamber 22c.

The swirling paths 21a, 21b, and 21c are fuel paths to supply fuel to the swirling chambers 22a, 22b, and 22c respectively. In this sense, the swirling paths 21a, 21b, and 21c may be called swirling fuel supply paths 21a, 21b, and 21c.

The wall surfaces of the swirling chambers 22a, 22b, and 22c are formed in a way that their curvatures gradually increase (their curvature radii gradually decrease) in the direction from upstream to downstream.

In each wall surface, the curvature may increase continuously or may increase step by step from upstream to downstream with a constant curvature in a given area.

Typical examples of curves (shapes) whose curvature increases continuously from upstream to downstream are involute curves (shapes) and spiral curves (shapes). This embodiment is explained on the assumption that a spiral curve (shape) is adopted. The above explanation is true when a curve whose curvature gradually increases from upstream to downstream as mentioned above is adopted.

The fuel injection holes 23a, 23b, and 23c lie in the centers of the swirling chambers 22a, 22b, and 22c respectively.

The nozzle body 2 and the orifice plate 20 are designed so that they can be simply and easily positioned with respect to each other using a tool (not shown) and when they are combined, high dimensional accuracy is assured.

The orifice plate 20 is produced by a press forming (plastic forming) process which is favorable for mass production. Alternatively it may be manufactured by another process which ensures high machining accuracy with relatively low stress, such as electrical discharge machining, electroforming, and etching.

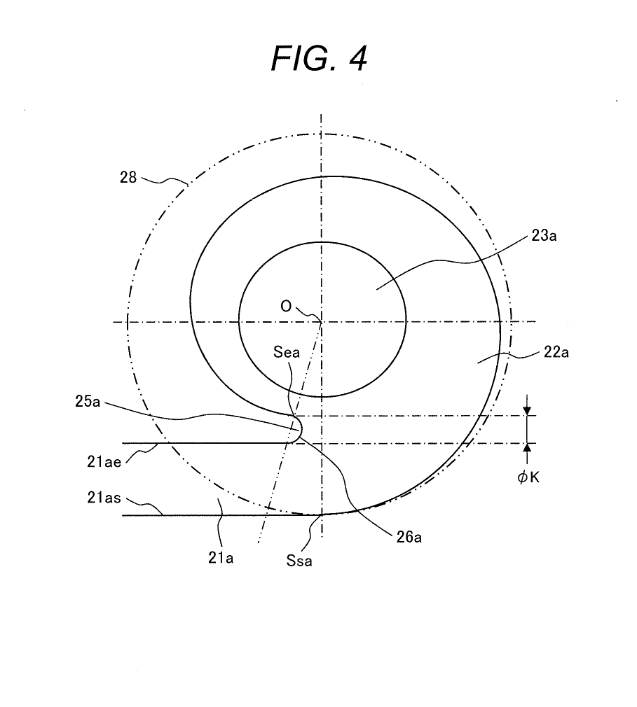

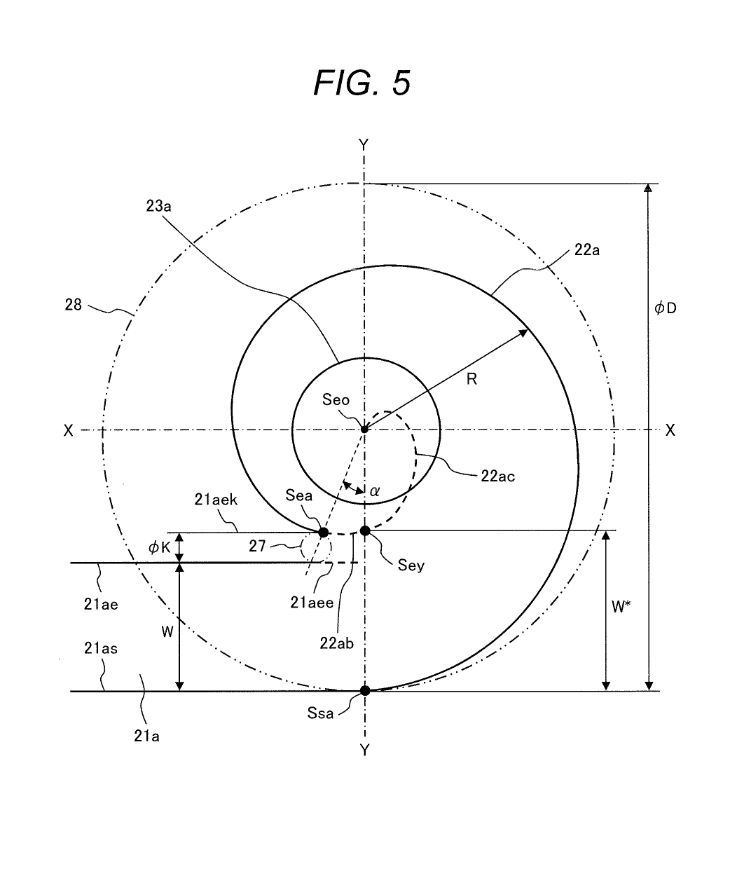

Next, how to form the swirling chamber 22a and its relation with the fuel injection hole 23a will be described in detail referring to FIGS. 4 and 5.

FIG. 4 is an enlarged plan view showing the relation among the swirling path 21a, swirling chamber 22a, and fuel injection hole 23a. FIG. 5 illustrates how the spiral swirling chamber 22a, swirling path 21a, and fuel injection hole 23a are formed.

The swirling path 21a communicates with, and opens to, the swirling chamber 22a in a tangential direction and the fuel injection hole 23a is located so that its center coincides with the swirl center O (which will be detailed later) of the swirling chamber 22a.

In this embodiment, the inner circumferential wall of the swirling chamber 22a is formed so as to depict a spiral curve on a plane (cross section) perpendicular to the valve axis line.

Next, how the spirally curved inner wall surface of the swirling chamber 22a is formed will be described referring to FIG. 5. In order to draw a spiral curve, usually the spiral radius R is gradually increased from the starting point (which corresponds to Seo in FIG. 5).

When the inner wall of a fuel path which swirls fuel forms a spiral curve as in this embodiment, for the sake of convenience the start end (starting point) and the finish end (ending point) are reversed because the position of the fuel introduction path is designed first. In this case, the fuel introduction path is the swirling path 21a with a path width W. A circle which is the basis for the size of the swirling chamber, namely a base circle 28 is expressed by an imaginary line in the figure. The center of this base circle 28 coincides with the starting point Seo of the above spiral curve.

Next, the procedure of making a spirally curved wall surface will be described.

First, path area da (width W by height H) of the swirling path 21a, diameter d0 of the fuel injection hole 23a and diameter φD of the base circle 28 as the basis for the size of the swirling chamber are extracted. For this extraction, values which are approximate to the requested specification are selected among various kinds of data obtained by experimentation in advance. Specifically such values are selected depending on the flow rate and injection angle which are required of the fuel injection valve.

Next, one sidewall 21as of the swirling path 21a which is circumscribed to the base circle 28 is drawn. The intersecting point Ssa at which it intersects with the Y axis of the base circle 28 is the start end (starting point) of the wall surface of the swirling chamber 22a.

Then, the other sidewall 21ae of the swirling path 21a is drawn. Here, since line segment 21aee is finally omitted, it is indicated by a broken line in the figure. The swirling path 21a is designed to have width W, and height H of the swirling path 21a is determined according to area da of the path.

Next, passing point Sea of the wall surface of the swirling chamber 22a and its intersecting point with the Y axis Sey (finish end, ending point) are defined as follows. First, line segment 21aek equivalent to thickness φK required for machining is drawn with a spacing of φK from the other sidewall 21ae in parallel.

Then, a point on the thickness φK line at which the spiral curve would begin to go beyond this outline is defined as passing point Sea.

This passing point Sea is expressed by angle α (17.5 degrees) with respect to the Y axis of the base circle 28 and the intersecting point Sey (finish end, ending point) between the spiral line segment passing this point and the Y axis of the base circle 28 is found. The distance between this intersecting point Sey and the start end (starting point) Ssa is newly defined as width W* of the swirling path.

The spiral curve is drawn so that radius R of the curve satisfies the relations expressed by Equation 1 and Equation 2.

R=D/2×(1−a×θ) (1)

a=W*/(D/2)/(2π) (2)

Here, D denote the diameter of the base circle and W* denotes the width of the swirling path. In the present invention, W* includes thickness φK (FIGS. 4 and 5).

An outline of a spiral wall surface (radius R) is drawn in accordance with the above equations.

Since the spiral wall surface segment 22ab between the passing point Sea and the intersecting point with the Y axis (finish end, ending point) is finally removed (no real wall surface exists in the area of this segment), it is indicated by a broken line. Furthermore, since the spiral wall surface segment 22ac from the finish end (ending point) Sey to intersecting point Seo at which a curve 180 degrees from it intersects with the Y axis is also finally removed and indicated by a broken line. This implies that the real finish end (ending point) of the wall surface which actually exists as the wall surface of the swirling chamber 22a is the passing point Sea.

Next, an arc of a circle 27 circumscribed with the passing point Sea as the real finish end (ending point) of the spiral wall surface is drawn. The function of this thickness φK will be described later.

Lastly, a fuel injection hole 23a is drawn so that its center coincides with the center of the base circle 28, namely the center Seo (starting point) of the spiral curve.

In the above structure, if fuel flows along the wall surface of the swirling chamber 22a, it would move from the passing point Sea as the real finish end (ending point) of the wall surface of the swirling chamber 22a through the spiral wall surface segments 22ab and 22ac indicated by broken lines toward the starting point of the spiral curve downstream.

Therefore, fuel flows along the spiral wall surface and its final point (swirl center) should exist in the center (starting point) of the spiral curve. This means that the final point exists in the center of the base circle 28.

Since the center of the fuel injection hole 23a exists in the center of the base circle 28, it should coincide with the swirl center of the flow along the spiral wall surface.

If the swirling chamber 22a is in the shape of an involute curve, the fuel injection hole 23a should be designed so that its center coincides with the center of the base circle for the involute curve.

Next, referring back to FIG. 4, the shape and function of the spiral-walled swirling chamber 22a will be described in detail.

As for the inner circumferential wall surface of the swirling chamber 22a, Ssa represents the start end (upstream end) and Sea represents the finish end (downstream end). The sidewall 21as of the swirling path 21a is connected to the start end (starting point) Ssa in a tangential direction from the starting point Ssa. At the finish point (ending point) Sea, a circular portion 26a is formed in away to contact the spiral curve at the ending point Sea.

The circular portion 26a extends across the entire height of the swirling path 21a and the swirling chamber 22a (in the direction along the swirl center axis), forming a partially cylindrical shape with a given angle range in the circumferential direction. The other sidewall 21ae of the swirling path 21a is formed in a way to contact the cylindrical surface of the circular portion 26a.

The cylindrical surface of the circular portion 26a is a connecting surface (intermediate surface) which connects the downstream end of the sidewall 21ae of the swirling path 21a and the finish end Sea of the inner circumferential wall of the swirling chamber 22a.

The connecting surface 26a constitutes a thickness formation part 25a in the joint between the swirling chamber 22a and the swirling path 21a so that the swirling chamber 22a and the swirling path 21a are connected with a wall surface with the given thickness φK between them. In other words, no sharp pointed shape like a knife edge exists in the joint between the swirling chamber 22a and the swirling path 21a.

The thickness formation part 25a is a wall surface which starts from the point Sea shown in FIG. 5 and is formed as the wall surface 26a constituting a circle with a given diameter circumscribed to the spiral curve of the swirling chamber 22a at the point Sea.

An extension of the sidewall (wall surface along the height direction) 21ae of the swirling path 21a does not intersect with an extension of the spiral curve of the inner circumferential wall surface of the swirling chamber 22a in an angle range of 180 degrees or more from the starting point Ssa of the spiral curve. Consequently a substantial thickness is produced between the sidewall 21ae and the spiral curve of the inner circumferential wall surface of the swirling chamber 22a.

The existence of the thickness formation part 25a prevents the formation of a sharp pointed part as seen in the related art and even if there is a slight misalignment in this part, a sharp drift toward the fuel injection hole 23as does not occur and the symmetry (uniformity) of a swirl flow is maintained.

In this embodiment, the direction to which the fuel injection holes 23a, 23b, and 23c open (fuel outflow direction, center axis line direction) is parallel to the valve axis of the fuel injection valve 1 and downward. Alternatively, the holes may open toward a desired direction at an inclination angle with respect to the valve axis so that fuel is injected diffusely (fuel injections from the holes are spaced from each other so as not to interfere with each other).

The cross section of the swirling path 21a perpendicular to the flow direction is rectangular and designed with dimensions convenient for press forming. In particular, for the sake of machinability, the swirling path 21a is designed in a way that its height HS is smaller than its width W.

Since this rectangular area (minimum sectional area) functions like a throttle for the fuel flowing into the swirling path 21a, fuel pressure loss, which may occur while the fuel flows from the seat part 3a of the valve seat face 3 through the fuel injection chamber 4, the fuel injection hole 5, and the center chamber 24 of the orifice plate 20 to the swirling path 21a, can be ignored.

In particular, the fuel injection hole 5 and the center chamber 24 of the orifice plate 20 are designed so that the fuel path has a required size to prevent turning pressure loss.

Therefore, fuel's pressure energy is efficiently converted into swirling speed energy in the swirling path 21a.

The flow accelerated in the rectangular part is led into the fuel injection hole 23a downstream while keeping a sufficient swirling intensity, namely swirling speed energy.

The relation among the swirling path 21b, swirling chamber 22b and fuel injection hole 23b and the relation among the swirling path 21c, swirling chamber 22c and fuel injection hole 23c are the same as the relation among the swirling path 21a, swirling chamber 22a and fuel injection hole 23a, so their descriptions are omitted here.

Although three sets of fuel paths (each set comprised of a swirling path 21, a swirling chamber 22, and a fuel injection hole 23) are provided in this embodiment, more sets may be provided to offer a variety of injection patterns and injection rates freely. Also, two sets of fuel paths (each set comprised of a swirling path 21, a swirling chamber 22, and a fuel injection hole 23) or one set may be provided.

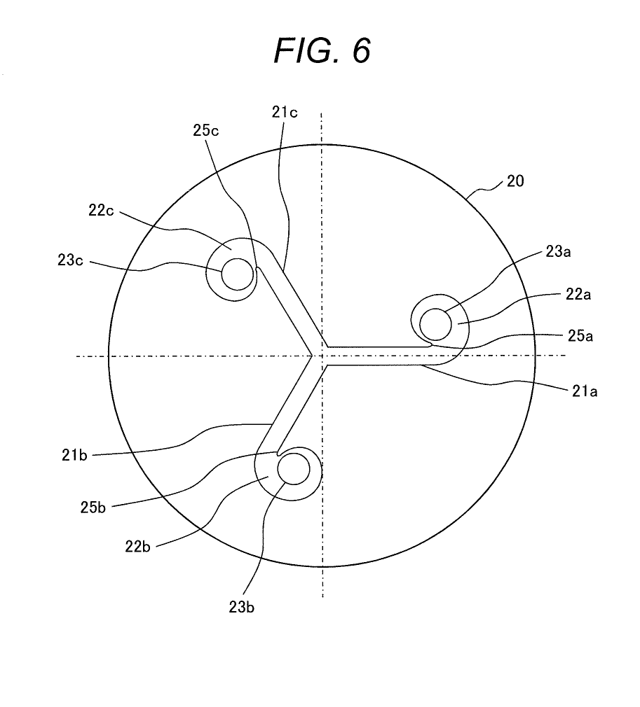

A possible alternative structure is as shown in FIG. 6, in which there is no center chamber 24 and swirling paths 21 are connected with each other. In this case, the dead volume of fuel is reduced due to the absence of a center chamber.

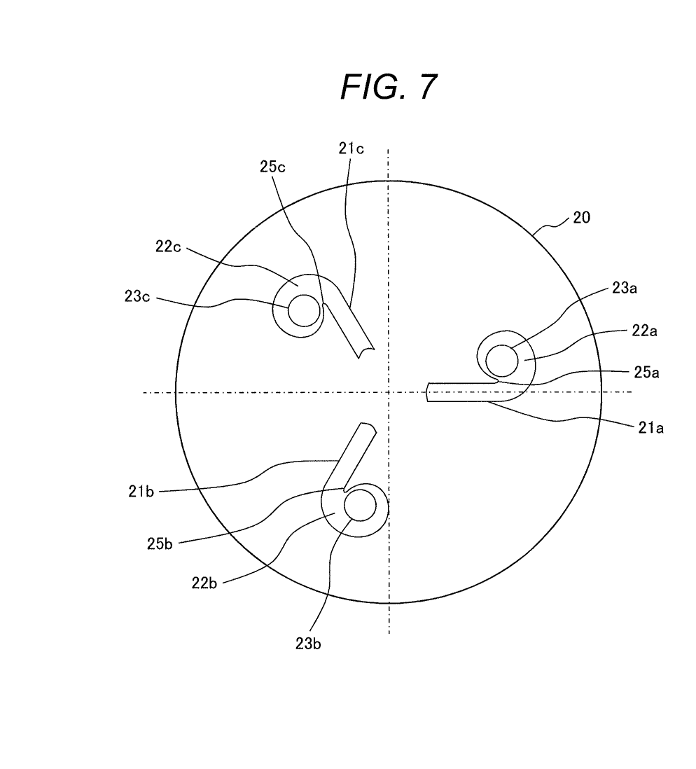

Another possible alternative structure is as shown in FIG. 7, in which swirling paths are not connected with each other. In this case, the dead volume of fuel is further reduced due to the absence of a center chamber and the shortness of swirling paths.

The circular portion 26a extends across the entire height of the swirling path 21 and the swirling chamber 22 (in the direction along the swirl center axis), forming a partially cylindrical shape with a given angle range in the circumferential direction.

Although the abovementioned structures are assumed to have the shape of a spiral curve, they may have the shape of an involute curve instead of a spiral curve.

Due to the thickness φK, the collision between the fuel circling in the swirling chamber 22 and the fuel inflowing from the swirling path 21 is lessened so that a smooth flow along the spiral wall surface of the swirling chamber 22 is ensured.

The above embodiments also have the following features and effects.

The diameter of the fuel injection hole 23 is large enough. This means that a cavity formed inside can be large enough. Therefore, a thin film of fuel can be formed without loss of swirling speed energy.

In addition, since the ratio of the fuel injection hole diameter to the thickness (equal to the swirling chamber height in this case) of the fuel injection hole 23 is small, loss of swirling speed energy is also very small. For this reason, fuel atomization characteristics are excellent.

Furthermore, since the ratio of the fuel injection hole diameter to the thickness of the fuel injection hole 23 is small, press workability is improved.

Due to these features, not only the cost is reduced but also workability is improved to minimize dimensional fluctuations so that robustness in terms of injection pattern and injection rate is remarkably improved.

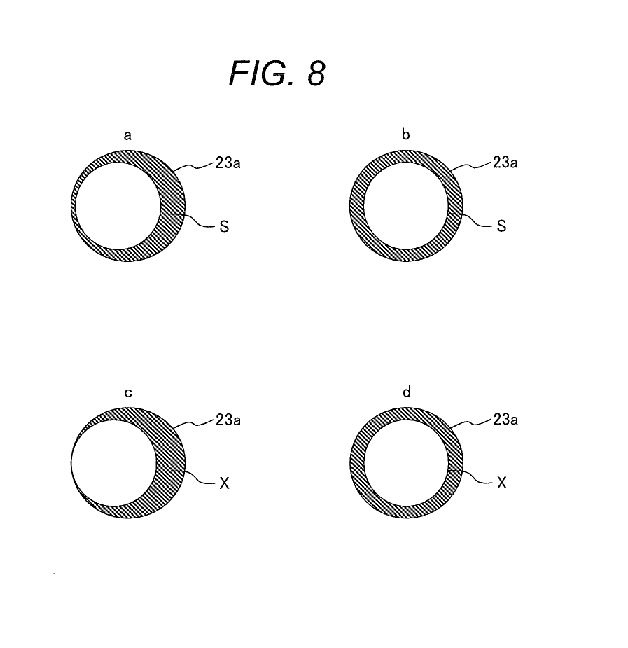

As explained so far, the fuel injection valve according to an embodiment of the present invention permits a fuel flow led to the spirally curved inner wall surface of the swirling chamber to move toward the center (swirl center) of the base circle to draw a spiral curve. Since the swirl center coincides with the center of the fuel injection hole, fuel flow S in the fuel injection hole as shown in FIG. 8B is more symmetrical with respect to the center than the fuel flow in the related art as shown in FIG. 8A. The symmetrical flow improves the injection pattern symmetry as shown in FIG. 8D, thereby promoting the formation of a thin film of fuel.

Since a fuel injection which uniformly forms a thin film in this way promotes energy exchange with the surrounding air, fuel atomization is accelerated just after fuel injection and a well atomized fuel is injected.

1. A fuel injection valve comprising:
a valve element provided movably;
a nozzle body including a valve seat face for the valve element to rest on in a valve closed state and having an opening downstream;
a swirling path communicating with the opening of the nozzle body and being located downstream of the opening;
a swirling chamber located downstream of the swirling path, in which fuel is swirled and given a swirling force; and
a fuel injection hole formed at a bottom of the swirling chamber to inject fuel outward, wherein
the swirling chamber has an inner wall surface which makes a spiral curve; and
the swirling chamber and the fuel injection hole are formed so that a center of a base circle for the spiral curve coincides with a center of the fuel injection hole.

2. The fuel injection valve according to claim 1, further comprising a circular portion formed by walls of the swirling chamber and the swirling path.

3. The fuel injection valve according to claim 1, wherein the spiral curve of the swirling chamber is drawn using the base circle larger than the swirling chamber and a width of the swirling path for introducing fuel into the swirling chamber.

4. The fuel injection valve according to claim 1, wherein a plurality of the swirling paths and a plurality of the fuel injection holes are provided and the swirling paths correspond to the fuel injection holes respectively and are independent from each other.

5. The fuel injection valve according to claim 2, wherein a plurality of the swirling paths and a plurality of the fuel injection holes are provided and the swirling paths correspond to the fuel injection holes respectively and are independent from each other.

6. The fuel injection valve according to claim 3, wherein a plurality of the swirling paths and a plurality of the fuel injection holes are provided and the swirling paths correspond to the fuel injection holes respectively and are independent from each other.
